(19) United States
(12) Patent Application Publication
(10) Pub. No.: US 2025/0236539 A1
(43) Pub. Date: Jul. 24, 2025

(54) PROCESSES AND SYSTEMS FOR REMOVING PER- AND POLYFLUOROALKYL SUBSTANCES FROM FLUIDS, SUCH AS POTABLE WATER, USING DIMETHYLETHANOLAMINE RESIN

(71) Applicant: Resintech, Inc., Camden, NJ (US)

(72) Inventors: Lawrence GOTTLIEB, Cherry Hill, NJ (US); Thomas SMITH, Erial, NJ (US); Michael GOTTLIEB, Delray Beach, FL (US)

(73) Assignee: Resintech, Inc., Camden, NJ (US)

(21) Appl. No.: 18/329,825

(22) Filed: Jun. 6, 2023

(51) Int. Cl. C02F 1/42; B01J 41/05; B01J 47/02; C02F 101/36

(52) U.S. Cl. CPC C02F 1/42; B01J 41/05; B01J 47/02; C02F 2001/422; C02F 2101/36; C02F 2209/40; C02F 2209/44

(57) ABSTRACT

The present disclosure relates to the use of a strongly basic anion exchange resin, in the form of dimethylethanolamine (DMAE) resin, for the removal of the per- and polyfluoroalkyl substances (PFASs) from fluids such as water.

### CROSS-REFERENCE TO RELATED APPLICATIONS

This application claims the benefit of U.S. application No. 63/064,581, filed Aug. 12, 2021, the contents of which are incorporated by reference herein in their entirety.

### FIELD

The present disclosure relates to the use of a strongly basic anion exchange resin, in the form of dimethylethanolamine (DMAE) resin, for the removal of the per- and polyfluoroalkyl substances (PFASs) from fluids such as water.

### BACKGROUND

The group of per- and polyfluoroalkyl substances is a diverse family of more than 4,700 different chemical compounds with a large range of physicochemical properties. PFASs are a class of drinking water contaminants that are highly persistent in nature due to their high chemical and thermal stability. PFASs are defined as chemical compounds with at least one perfluorocarbon moiety (—CF₂—), with polyfluoroalkyl compounds containing partly fluorinated alkyl chains and perfluoroalkyl substances containing fully fluorinated carbon chains.

PFASs exhibit unique properties, including high polarity, extremely high thermal and chemical stability, low volatility, and high solubility in water. Many PFASs have both hydrophobic and oleophobic properties, and the carbon fluorine bond in PFASs is among the strongest of chemical bonds.

PFASs are able to undergo long-range transport, and to accumulate in living organisms. PFASs often are found in potable water sources throughout the world in detectable concentrations. Due to the extreme persistence of PFASs, and established correlations between PFAS exposure and various types of cancer and other adverse health effects, many PFASs present a significant risk to human health.

Ion exchange resins are made of highly porous, polymeric materials typically formed as small beads having a diameter of 0.5 to 1.0 mm. The microbeads form an insoluble matrix, or support structure. Ion exchange sites are provided throughout the polymer matrix. Each ion exchange site includes a functional group of either positively-charged ions (cations) or negatively-charged ions (anions) affixed to the polymer network. These functional groups readily attract ions of an opposing charge. The trapping of such ions by the functional group, in conjunction with the accompanying release of other ions from the functional group, constitutes a process called ion exchange.

Positively charged, strongly basic anion exchange resins have been proven effective in removing negatively charged contaminants, like PFASs, from water. The negatively charged ions of the PFAS are attracted to the positively charged anion resin, causing the PFAS to deposit onto the surface of the resin beads and in effect removing the PFAS from the water.

Tributylamine (TBA)-based resins can remove PFAS from water, and possess a greater capacity than many other resins in removing PFASs. Ion exchange resins with TBA functionality, in connection with granular activated carbon, have been used commercially, and have proven highly effective in reducing or eliminating PFASs in potable water. TBA resins, however, have disadvantages. For example, the process of attaching tributylamine to the polymeric matrix of an ion exchange resin is relatively difficult. Thus, the manufacturing process for TBA resins is somewhat complex, making TBA resins expensive in relation to other types of resins. Also, the commercial availability of TBA at times is limited, further increasing the expense of manufacturing TBA resins. Moreover, TBA resins can produce an unpleasant odor, and can be toxic when present above trace levels; these characteristics are particularly undesirable in applications where the resin is used to purify potable water.

### SUMMARY

In one aspect of the disclosed technology, a process for removing perfluoroalkyl and/or polyfluoroalkyl substances from a fluid includes providing an ion exchange system having a column defining an internal volume, and a bed of dimethylethanolamine resin disposed in the internal volume; and introducing the fluid into the column so that the fluid contacts the dimethylethanolamine resin.

In another aspect of the disclosed technology, introducing the fluid into the column so that the fluid contacts the dimethylethanolamine resin includes introducing the fluid into the column so that the fluid contacts the dimethylethanolamine resin for a length of time sufficient to cause the perfluoroalkyl and/or polyfluoroalkyl substances to become deposited on the dimethylethanolamine resin.

In another aspect of the disclosed technology, introducing the fluid into the column so that the fluid contacts the dimethylethanolamine resin for a length of time sufficient to cause the perfluoroalkyl and/or polyfluoroalkyl substances to become deposited on the dimethylethanolamine resin includes controlling a flow rate of the fluid through the column.

In another aspect of the disclosed technology, introducing the fluid into the column so that the fluid contacts the dimethylethanolamine resin includes introducing the fluid into the column so that the fluid passes through the bed of dimethylethanolamine resin.

In another aspect of the disclosed technology, providing an ion exchange system having a column defining an internal volume, and a bed of dimethylethanolamine resin disposed in the internal volume includes providing an ion exchange system comprising a bed of dimethylethanolamine resin beads.

In another aspect of the disclosed technology, a process for purifying water includes placing the water in contact with a dimethylethanolamine resin for a period of time sufficient to remove perfluoroalkyl and/or polyfluoroalkyl substances from the water.

In another aspect of the disclosed technology, placing the water in contact with a dimethylethanolamine resin for a period of time sufficient to remove perfluoroalkyl and/or polyfluoroalkyl substances from the water includes placing the water in contact with the dimethylethanolamine resin for a period of time sufficient for the perfluoroalkyl and/or polyfluoroalkyl substances to become deposited on the dimethylethanolamine resin.

In another aspect of the disclosed technology, placing the water in contact with a dimethylethanolamine resin for a period of time sufficient to remove perfluoroalkyl and/or polyfluoroalkyl substances from the water includes placing the water in contact with a bed of dimethylethanolamine resin beads for a period of time sufficient to remove perfluoroalkyl and/or polyfluoroalkyl substances from the water.

In another aspect of the disclosed technology, placing the water in contact with a bed of dimethylethanolamine resin beads for a period of time sufficient to remove perfluoroalkyl and/or polyfluoroalkyl substances from the water includes controlling a flowrate of the water over the bed of dimethylethanolamine resin beads.

In another aspect of the disclosed technology, an ion exchange system for removing perfluoroalkyl and/or polyfluoroalkyl substances from a fluid includes a column defining an internal volume; a bed of dimethylethanolamine resin disposed in the internal volume; and a valve system configured to, during operation, control a flowrate of the fluid through the column.

In another aspect of the disclosed technology, the valve system includes an inlet valve configured to meter an inflow of the fluid into the internal volume; and an outlet valve configured to meter an outflow of the fluid from the internal volume.

In another aspect of the disclosed technology, the system also includes a controller configured to control opening and closing of the inlet and outlet valves.

In another aspect of the disclosed technology, the bed of dimethylethanolamine resin includes a bed of dimethylethanolamine resin beads.

In another aspect of the disclosed technology, the system further includes a layer of activated carbon disposed in the internal volume.

### BRIEF DESCRIPTION OF THE DRAWINGS

The following drawings are illustrative of particular embodiments of the present disclosure and therefore do not limit the scope of the present disclosure. The drawings are intended for use in conjunction with the explanations in the following detailed description.

FIG. 1 is a diagrammatic illustration of an ion-exchange system that can be used to remove PFASs from a fluid.

FIG. 2 is a tabular listing of the types of PFASs used in a two-phase, fixed-bed column study to evaluate the relative effectiveness of DMAE resin and a TBA resin at removing of PFASs from water.

FIG. 3 is a tabular listing of the concentrations of the PFASs in the water samples used in the fix-bed column study.

FIGS. 4-9 are graphical representations of the relative effectiveness of the DMAE and TBA resins at removing the PFASs from the water samples during phase one of the fixed-bed column study.

FIG. 10 is a tabular summary of the time for the concentration of the PFASs in the treated water to reach to reach a 15 ppt threshold during phase one of the fixed-bed study, for each PFAS.

FIGS. 11-16 are graphical representations of the relative effectiveness of the DMAE and TBA resins at removing the PFASs from the water samples during phase two of the fixed-bed column study.

FIG. 17 is a tabular summary of the time for the concentration of the PFASs in the treated water to reach to reach a 15 ppt threshold during phase 2 of the fix-bed column study, for each PFAS.

FIG. 18 is a tabular summary of the PFAS removal, on a percentage basis, achieved by the TBA and DMAE resins for each PFAS during phases one and two of the study.

FIG. 19 is a graphical representation of the relative equilibration stir rates for three of the PFASs used in the fixed-bed column study, on the DMAE resin.

FIGS. 20-22 depict various examples of theoretical simulated capacity/leakages fits to the column exhaustion data during phase one of the fixed-bed column study.

FIGS. 23-25 depict examples of theoretical simulated capacity/leakages fits to the column exhaustion data using proprietary simulation software.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” (or “comprises”) means “including (or includes), but not limited to.” When used in this document, the term “exemplary” is intended to mean “by way of example” and is not intended to indicate that a particular exemplary item is preferred or required.

### Ion Exchange System

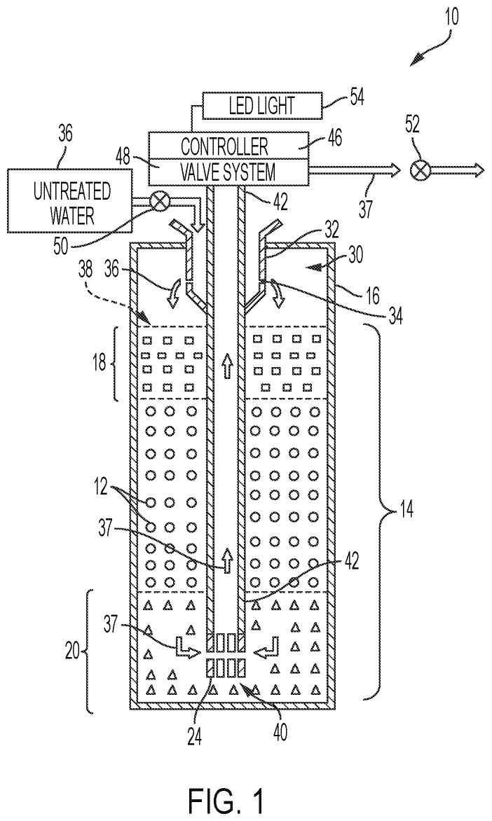

Processes and systems for removing PFASs from a fluid using a DMAE ion exchange resin are disclosed herein. FIG. 1 depicts an exemplary ion exchange system 10 for treating a fluid, such as liquid water, by passing the fluid across an ion exchange resin in the form of a DMAE resin 12. Details of the ion exchange system 10 are presented for illustrative purposes only. The DMAE resin 12 can be used in ion exchange systems having other configurations.

In an ion exchange process, fluid is passed across an ion exchange resin, such as the DMAE resin 12, to remove ions from the fluid by exchanging the ions in the fluid with other ions in the ion exchange resin. The ion exchange resin removes charged ions from the liquid by exchanging them for an equivalent amount of other charged ions in a reversible chemical reaction.

The DMAE resin 12 is in the form of resin beads of, for example, about 0.5 mm to about 1.0 mm diameter, formed by a highly porous, polymeric matrix with functional groups of DMAE deposited throughout the matrix. The resin beads collectively form a bed that partially fills an internal volume of a column 14 in a cylindrical tank 16 of the system 10. An untreated liquid 36 passing through the internal volume in the column 14 contacts the resin bed. The untreated liquid can be, for example, water containing contaminants such as one or more types of PFASs. The resulting attraction between the negatively charged ions of the PFAS and the positively charged anion resin causes the PFASs to deposit onto the surface of the resin beads, removing the PFASs from the liquid and producing treated liquid 37. The removal of the contaminants is related to the flow rate of the liquid 36 through the column 14, and more specifically, by the empty bed contact time (EBCT) between the DMAE resin 12 and the liquid 36. As discussed below, the tank 16 and the volume 14 can be sized and otherwise configured to provide an optimal combination resin bed height, pressure loss, and flow rate for a particular application.

The column 14 can include other purification and conditioning materials. For example, the column 14 can include an activated carbon layer 18 to remove organic contaminants, such as organic molecules, from water. Organic particles often are responsible for undesirable taste, odor, and/or color in drinking water. The column 14 also can include a permeation layer 20, such as a layer of gravel (as shown) or a wedge-shaped wire structure (not shown) located at the bottom of the column 14. The permeation layer has perforations that are sized to allow treated water 37 to leave the tank 16, while retaining the DMAE resin 12 and resin fines in the tank 16. Resin fines are caused by wear and tear that normally occur during the service life of the DMAE resin 12, and enhance the ion exchange process. The permeation layer 20 can be made from, for example, aluminum oxide or garnet beads. Alternatively, a suitable wedge-shaped wire structure can be used as the permeation layer and can be made from, for example, a polymer such as polyvinyl chloride; a metal such as stainless steel; or combinations of the same, which does not degrade or leach chemicals into the treated water solution. A sieve 24 can be provided to retain the permeation layer 20, while allowing treated liquid 37 to exit the permeation layer 20.

The tank 16 also has a top portion 30 with a liquid distributor inlet 32. The liquid distributor inlet 32 is shaped, and configured with holes 34 to distribute untreated liquid 36 across the top cross-sectional area 38 of the tank 16. The distributed untreated liquid 36 is filtered and treated as it flows through the column 14, under gravity or pressure, from the top portion 30 to a bottom portion 40 of the tank 16, to yield treated liquid 37 at the bottom portion 40. The treated liquid 37 passes through the permeation layer 20 and the sieve 24 and into an outlet tube 42. The outlet tube 42 extends from the bottom portion 40 to, and out of, the top portion 30 of the tank 16, to exit the tank 16.

The system 10 also can include an ion exchange controller 46 that controls a valve system 48 connected to the liquid distributor inlet 32 and the top of the outlet tube 42, to control the flow of untreated liquid 36 and treated liquid 37 into and out of the system 10. The controller 46 comprises programmable electronics and hardware to send signals to control the valve system 48. For example, the controller 30 can open an inlet valve 50 to allow untreated liquid 36 into the column 14 of the tank 16 until the tank 16 is full of liquid, and at that time, shut the inlet valve 50. Also, the controller 30 can open an outlet valve 52 to release treated liquid 37 as needed.

After a number of liquid treatment cycles, the DMAE resin 12 becomes spent and saturated with ions extracted from the liquid, and can lose exchange efficiency from being plugged up by solids. The controller 46 can activate an LED light 54 or other alarm system that indicates when the DMAE resin 12 is spent. The controller 30 can trigger the LED light 54 in relation to the number of gallons of untreated liquid 36 that have passed through the column 16; the number of water treatment cycles; or a clock (not shown) that counts the operational time since the last replacement of the DMAE resin 12. When the controller 46 signals that the resin 12 has become, or is estimated to become, spent, an operator can remove the tank 16 and replace the spent resin tank with a new tank containing fresh DMAE resin 12.

### Comparison of DMAE and TBA Resins

The inventors conducted a comparative fixed-bed column study to evaluate the relative effectiveness of DMAE resin and a TBA resin at removing several different types of PFASs from water. The bead size for both the TBA and DMAE resins varied in a standard Gaussian distribution. In practice, DMAE resin used for the reduction of PFAS levels also can have a uniform bead size.

The PFASs used in the studies included organic acid and organic sulfonates, with low and high carbon chain lengths. These compounds are considered to be a representative set of compounds based on their prevalence in potable water supplies. The results showed that the performance of the DMAE resin was about equal to, or better than the performance of the TBA resin at reducing the concentration of the PFASs used in the study.

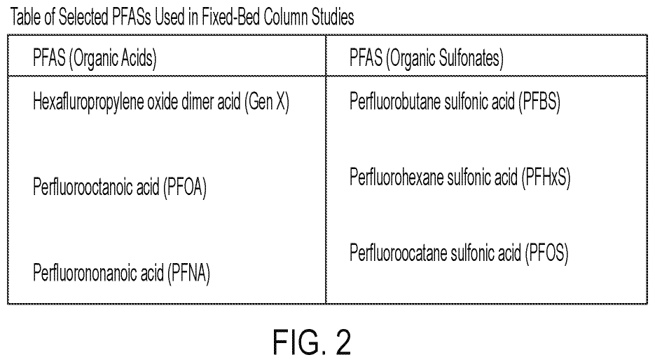

The PFASs that were used in this study included HFPO-DA (Gen X), PFOA, PFAS, PFNA, PFBS, PFHxS. These PFASs have varied chemistries, with carbon chain length ranging from four to nine, and organic acid and sulfonate characteristics. Also, all of these compounds have been well established in test methods of the Environmental Protection Agency (EPA), and are some of the most common compounds found in typical groundwater. The PFASs used in the study are listed in tabular form in FIG. 2.

PFASs typically are analyzed using liquid chromatography/mass spectrometry (LC/MS/MS)-based analytical methods. The inventors developed two methods to determine the levels of the PFASs present in the water used in this study. A direct injection LC/MS/MS method, based on EPA Method 8327, was used for levels of PFASs greater than about 70 ppt. A solid phase extraction-based LC/MS/MS analytical method, based on EPA Method 537.1, was developed to successfully analyze the PFASs at trace concentrations, i.e., at concentrations less than about 70 ppt.

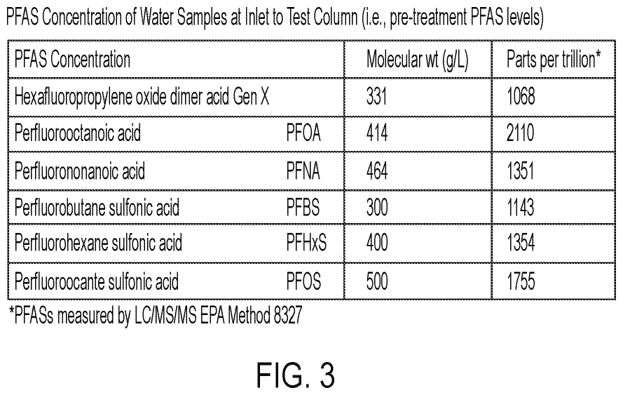

Berlin, New Jersey cold tap water was used for the study. The tap water, as supplied, was untreated for naturally occurring matter (NOM), and was supplied to the laboratory where the study was conducted. Tap water in this part of New Jersey typically contains about 3 ppt to about 20 ppt total PFASs. Limits of 14 ppt have been instituted for PFOA, PFOS and PFNA in many states throughout the United States. For the evaluations with each particular PFAS compound, the tap water was spiked with about 1000 ppt to about 2000 ppt of each PFAS compound, to provide an individual sample spiked with that particular PFAS compound. FIG. 3 is a tabular listing of the concentrations of the various PFASs in the samples used in the study.

Identical side by side fixed-bed columns were used to evaluate the respective effectiveness of the DMAE and TBA resins at removing PFASs from the sample water. One column included a bed of the DMAE resin; the other column included a bed of the TBA resin. Standard test rigs were used to provide the spiked water samples to each column, at the required flow rates. The spiked tap water was continuously fed downward into each column by gravity, and through the bed of DMAE or TBA resin. Samples were collected periodically, and were analyzed using the above-noted techniques to determine the levels of PFSAs in the water after passing through the resin bed.

The study was conducted in two phases. During the first phase, the flow rate of the water sample through the column was relatively high. Specifically, the empty bed contact time (EBCT) was about ten minutes, which equated to a flowrate of about 0.75 gpm (gallons per minute) per cubic foot of bed area. The flow rate of the water sample was reduced during the second phase. Specifically, the EBCT during the second phase was about 20 minutes, which equated to about 0.375 gpm per cubic foot of sample water flow per cubic foot of bed area.

### Results of Column Study, Phase One

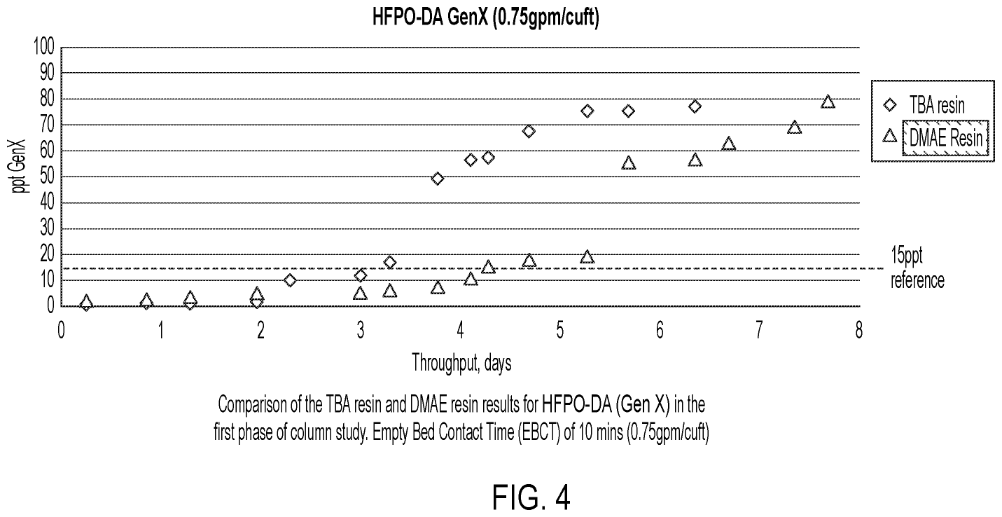

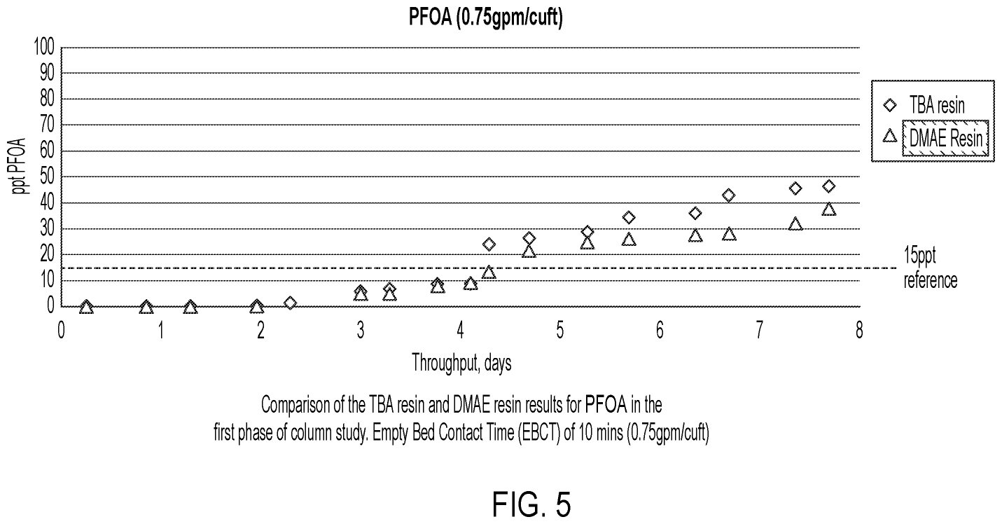

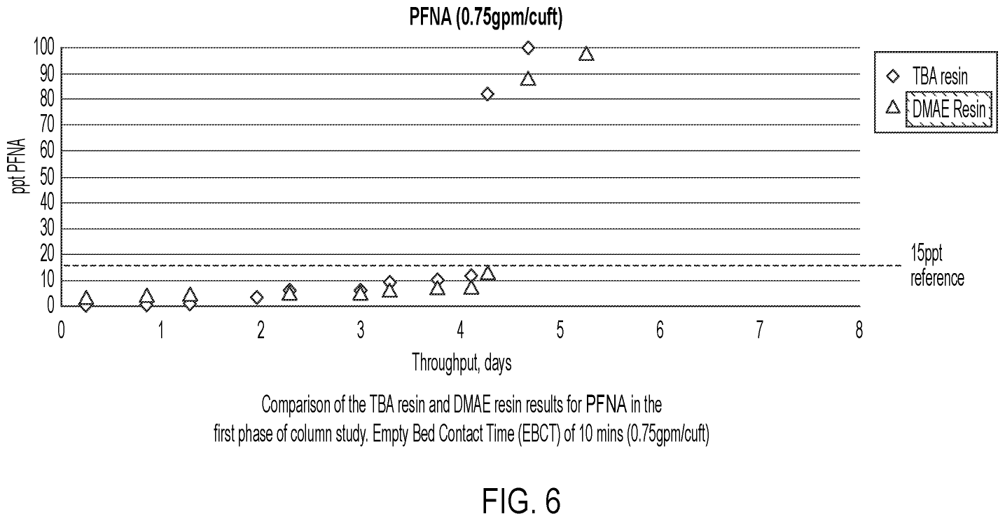

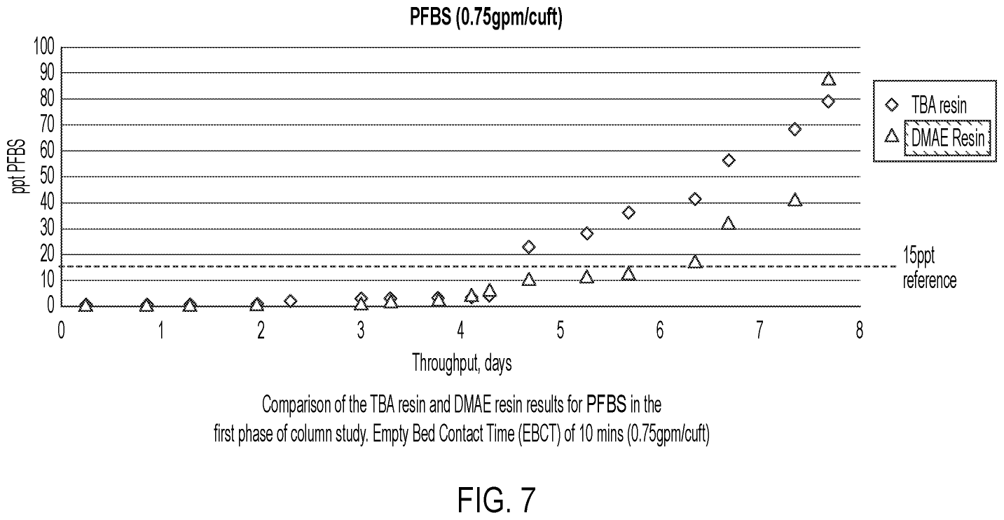

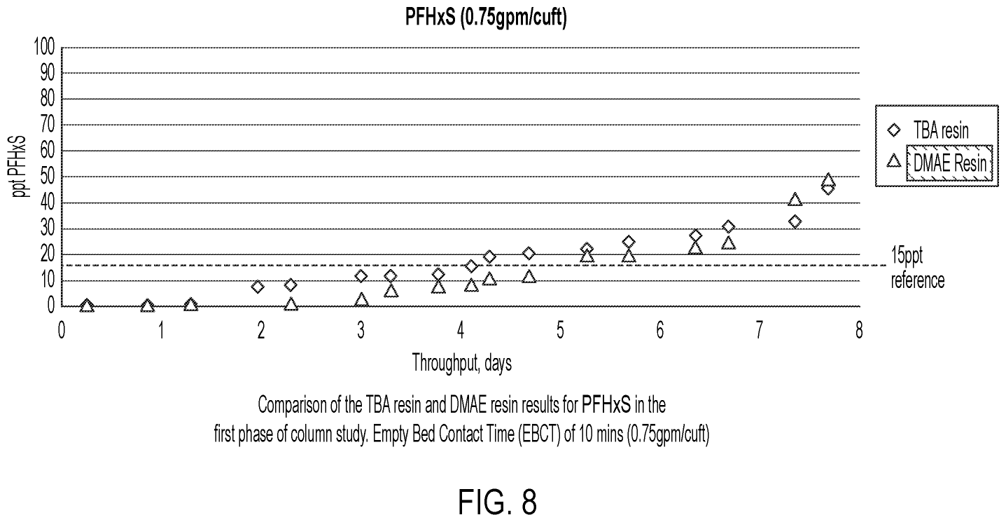

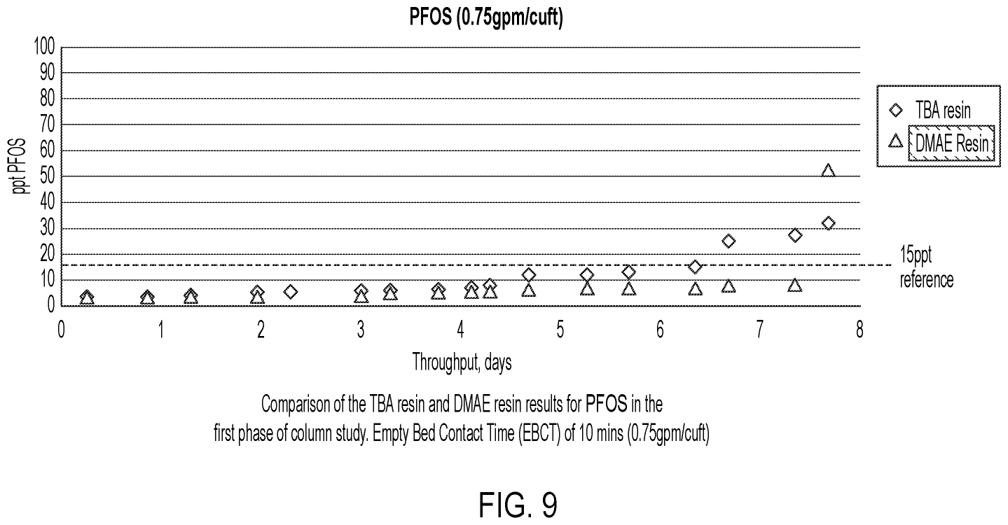

FIGS. 4-9 show the results for the TBA resin and the DMAE resin during the first phase of the study. These figures each include a 15 ppt PFAS reference line, which is based loosely on the PFAS limits that currently are being established at many state levels. The operating parameters during the phase one evaluation were: an EBCT of about 10 minutes, equating to about 0.75 gpm of water flow per cubic foot of bed area; and an ambient temperature of about 23° C. +/−2° C.

FIGS. 4-9 illustrate the relative effectiveness of the DMAE and TBA resins at removing the respective PFASs from the water samples during the phase one study. As can be seen in these figures, the DMAE resin performed generally as well, or better than the TBA resin. Specifically, the measured PFAS levels, in general, were generally the same, or lower in the water samples treated by the DMAE resin, in comparison to the samples treated with TBA resin, at the same throughput values.

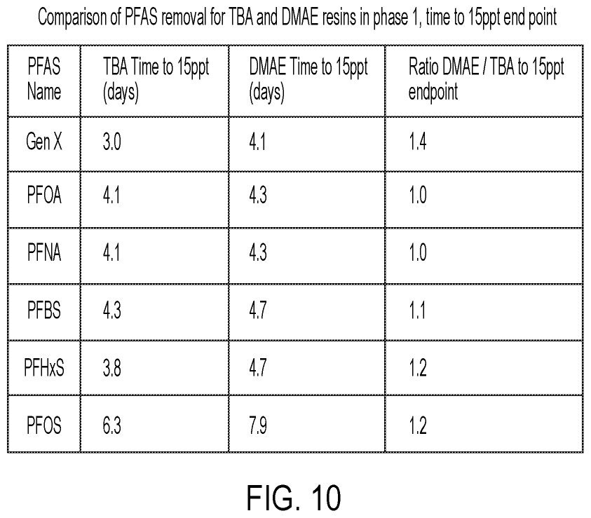

Also, the DMAE resin reached a higher throughput, as measured in total days of use, before it no longer was able to maintain the PFAS levels below the 15 ppt threshold. FIG. 10 is a tabular summary of the time for the treated water to reach the 15 ppt threshold during the phase one study, for each PFAS. As can be seen in FIG. 10, in all cases, the PFSA levels in the water treated with the DMAE resin reached the 15 ppt threshold later than the water treated with the TBA resin. Thus, the results of the phase one study indicate that the DMAE resin had a longer effective life than the TBA resin before the DMAE resin needed to be regenerated or discarded.

### Results of Column Study, Phase 2

During phase two of the study, the flowrate of the water through the column was reduced to 1/20th bed volume (BV) per minute, which equated to about 0.375 gpm per cubic foot. The ambient temperature was maintained at about 23° C. +/−2° C. The TBA or DMAE resin in each column was not replaced when transitioning between the first and second phases of the study with each particular PFAS.

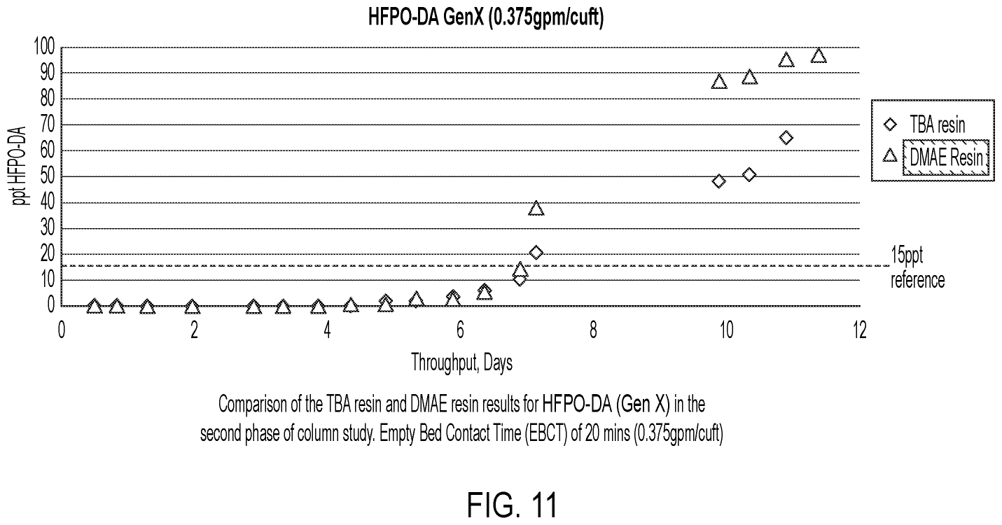

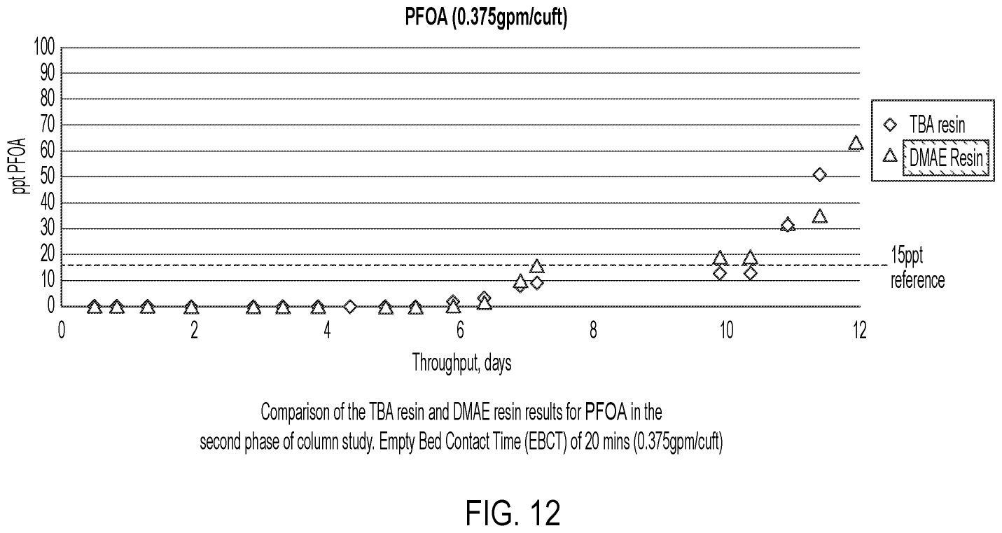

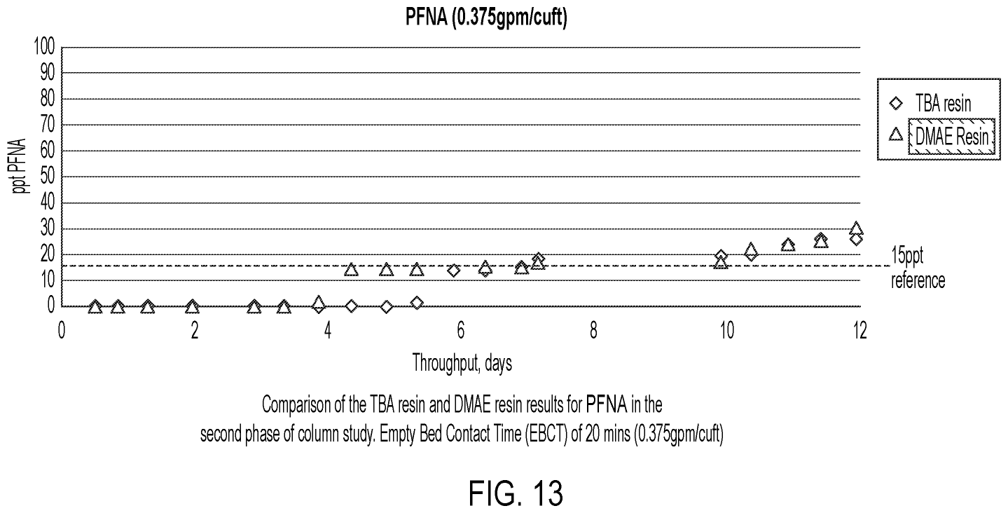

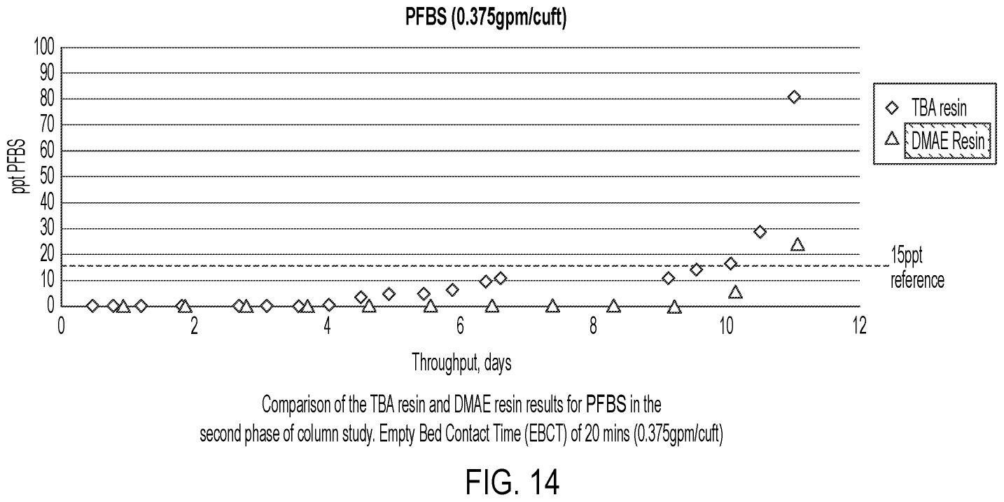

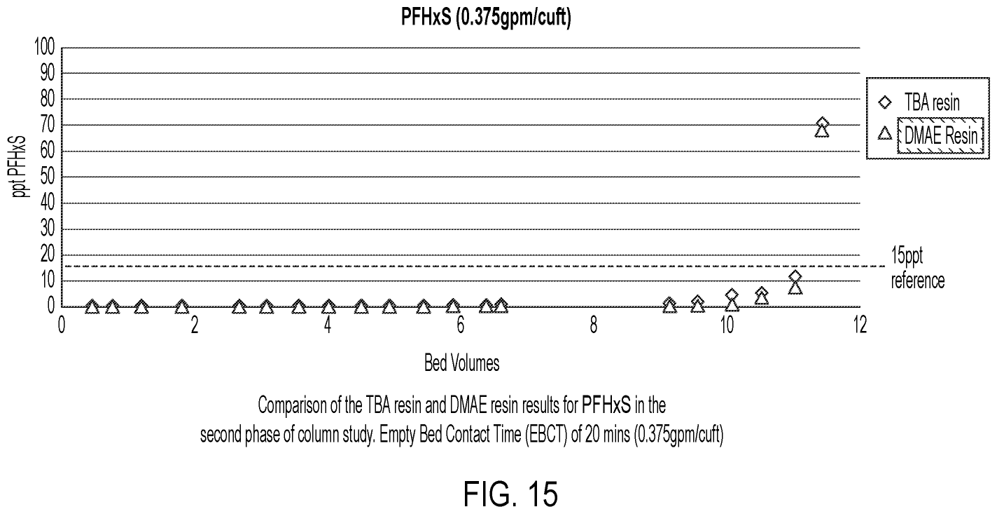

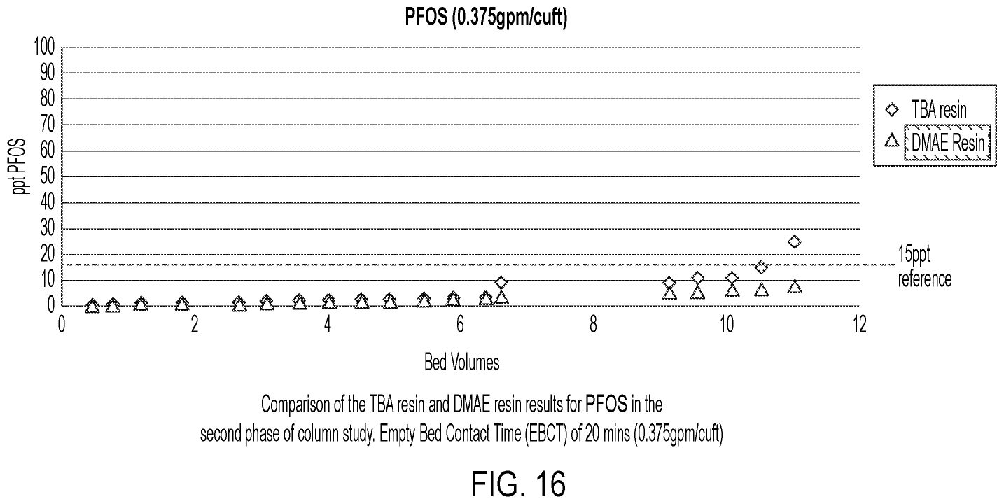

FIGS. 11-16 show the results for the second phase of the study, for each respective PFSA that was evaluated. The throughput values represent the additional number of days that the columns lasted after the flow rate reduction at the beginning of the second phase. (The as-measured level of each PFAS returned to about zero at the start of the second phase due to the increased removal efficiency associated with the lower flowrate in the second phase.)

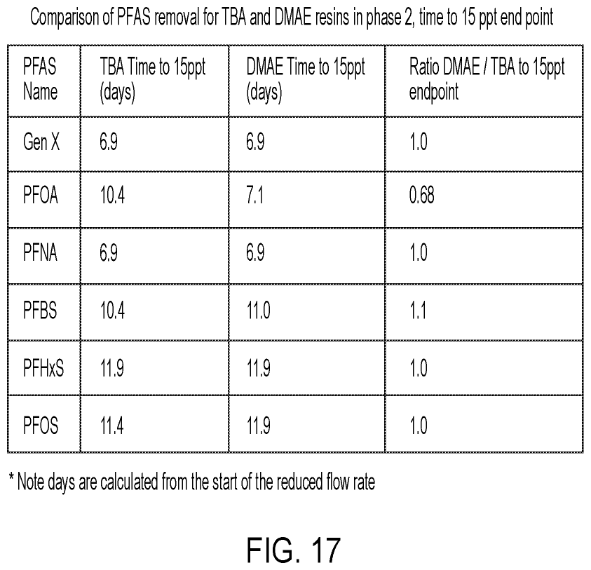

With the exception of one of the PFSAs, the DMAE resin performed generally as well, or better than the TBA resin in the second phase, with the measured PFAS levels being generally the same, or lower in the water samples treated by the DMAE resin, in comparison to the samples treated with TBA resin, at the same throughput values. Also, FIG. 17 is a tabular summary of the time for the treated water to reach the 15 ppt threshold during the phase two study. As can be seen in this figure, with one exception, the PFSA levels in the water treated with the DMAE resin reached the 15 ppt threshold later than the water treated with the TBA resin.

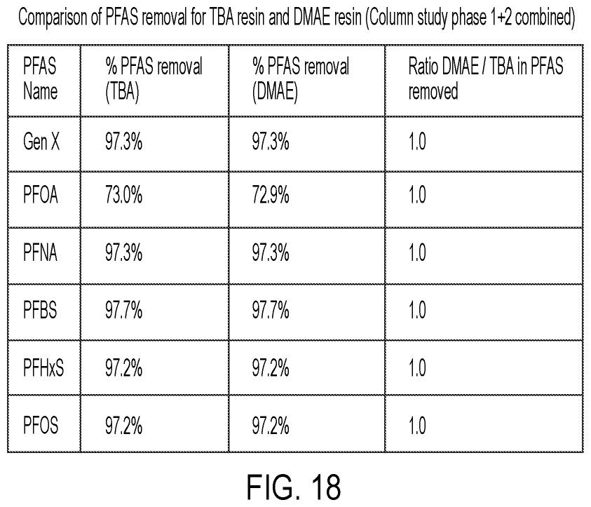

FIG. 18 is a tabular summary of the PFAS removal, on a percentage basis, achieved by the TBA and DMAE resins for each PFAS. The summary combines the results of phases one and two. This data indicates that the DMAE resin, in general, was about as effective as the TBA resin in reducing the levels of the various PFSAs in water.

The comparable effectiveness of the DMAE and TBA resins in eliminating PFASs from water is significant, because the DMAE resin possesses various advantages in relation to the TBA resin. As discussed above, TBA resins are considered highly effective in removing PFSAs from potable water. TBA resins, however, can be relatively complicated and expensive to produce, may not be readily available when needed, can add an unpleasant odor and coloring to water, and can be toxic at levels above trace levels. The DMAE resin, by contrast, is readily available, does not produce a foul odor or coloration in treated water, and is non-toxic at the residual levels normally found in water that has been treated for PFSAs. Also, DMAE is relatively easy to produce, and can be procured at a cost about 60 percent lower than that of TBA resins, allowing for more gallons of water to treated per unit cost. Moreover, the DMAE resin is more resistant than TBA resins to fouling by naturally occurring matter. Thus, the DMAE resin lacks many of the disadvantages the TBA resins, while being comparable to TBA resins at eliminating PFSAs from water. These factors make DMAE resin an attractive alternative to TBA resins in the treatment of drinking water.

### The Effects of Molecular Kinetics on PFAS Removal

Due to molecular kinetics, high EBCTs are required for any resin used in the treatment of PFASs. Adsorption isotherms for the DMAE resin were studied, to obtain relative affinities for PFASs on the resin, and to study the kinetics of the ions associated with the DMAE resin. In conventional ion exchange, e.g., water softening and nitrate removal, the ions of interest are relatively small and kinetically fast; and equilibrate within minutes, or at the most, several hours. PFAS compounds, by contrast, have higher molecular weights, ranging from about 300 g/l to about 500 g/l. These molecular weights are similar to those of some of the naturally occurring organics that hamper conventional ion exchange.

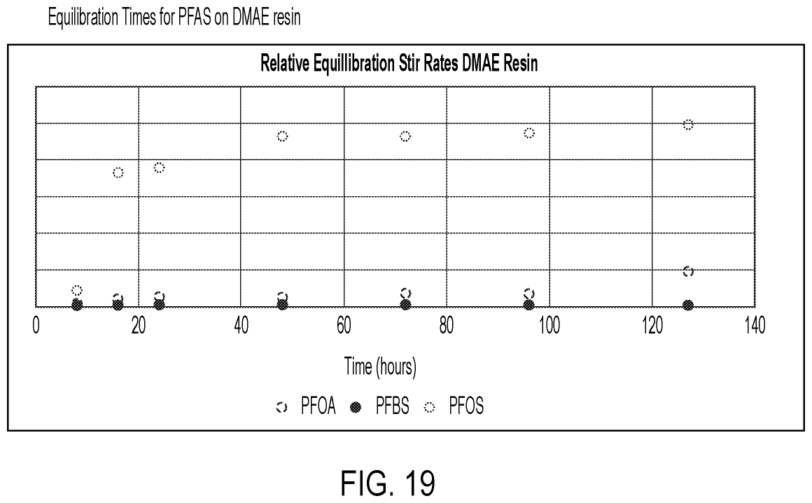

It was observed that the time required for above-noted PFASs used in the fixed-bed column studies to reach equilibration was as great as several days, which is much longer than the equilibration times of a few minutes for common ions in potable water. This can be seen in FIG. 19, which depicts the relative equilibration stir rates for three of the PFASs used in the fixed-column study, on the DMAE resin. Due to the very slow kinetics of the PFASs with ion exchange resins, contact time and flowrate are key parameters in the removal of PFASs using such resins.

Affinity for the resin, in general, increases with increasing PFAS size. Affinity, however, is not the only factor involved in the ion exchange. Kinetics plays a very important role in the overall removal of PFASs. While the smaller compounds have comparatively lower affinity for the resin, they are more kinetically efficient at exchanging onto the resin. Thus, when examining real-world feasible flow rates, PFAS removal rates are relatively similar to one another despite the differences in relative affinity, but much slower than the removal rates of common ions in potable water.

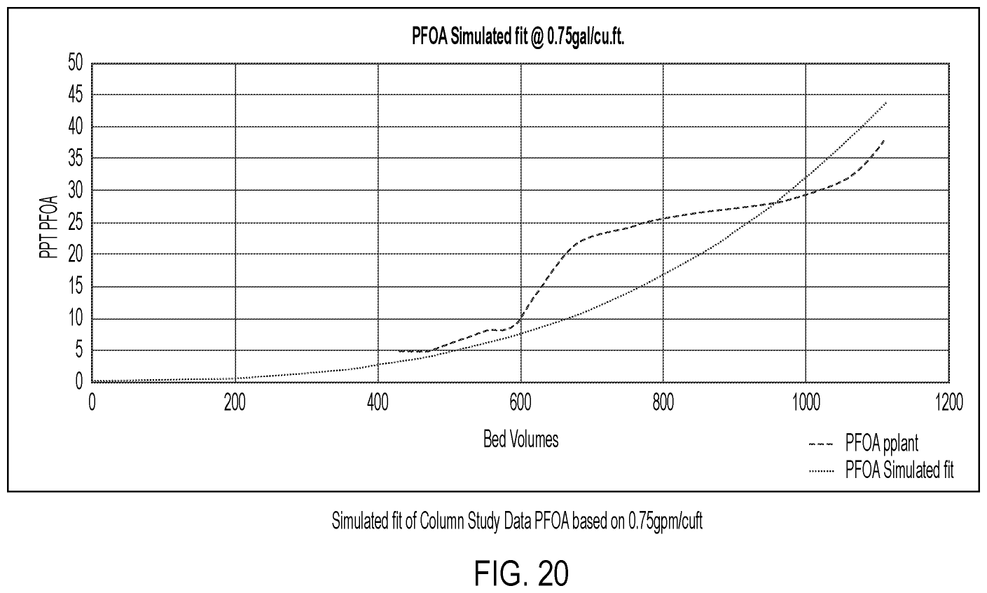

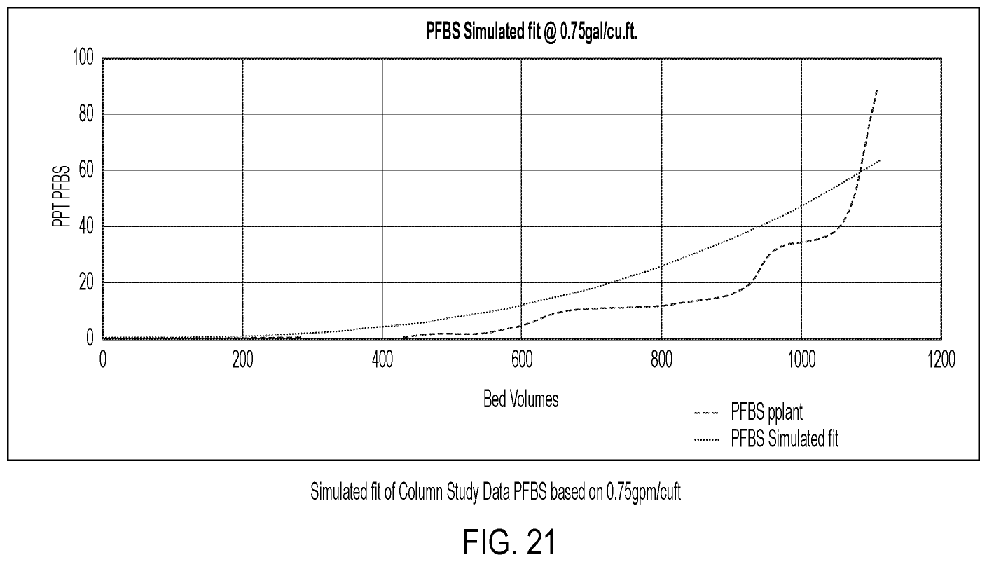

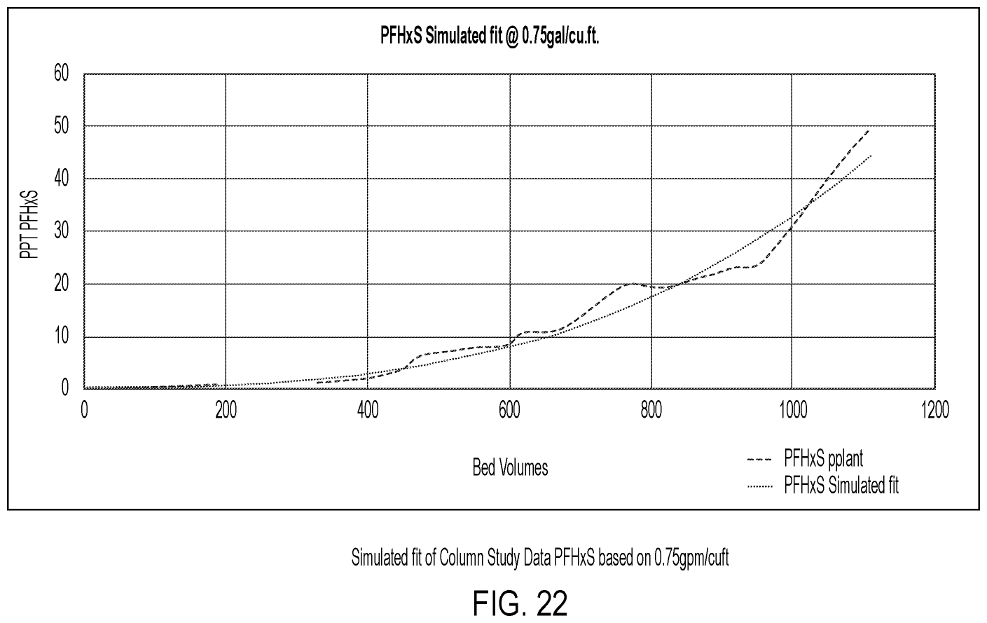

FIGS. 20-22 depict various examples of theoretical simulated capacity/leakages fits to the column exhaustion data during phase one of the column study, at 0.75 gpm per cubic foot ( 1/10 BV/min) flow rate; for reference, 1000 BV is seven days of run length at this flow rate.

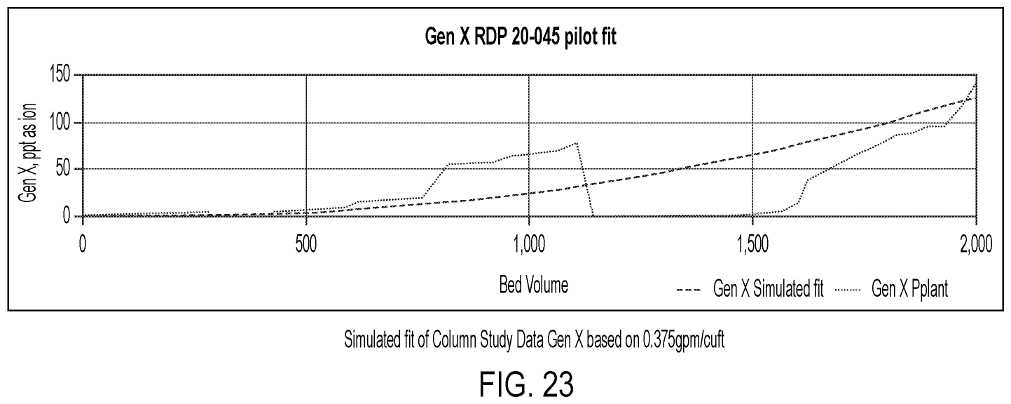

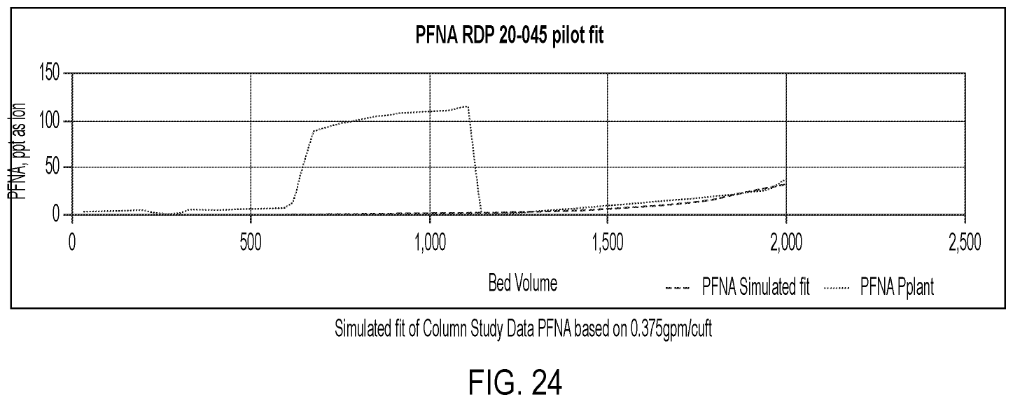

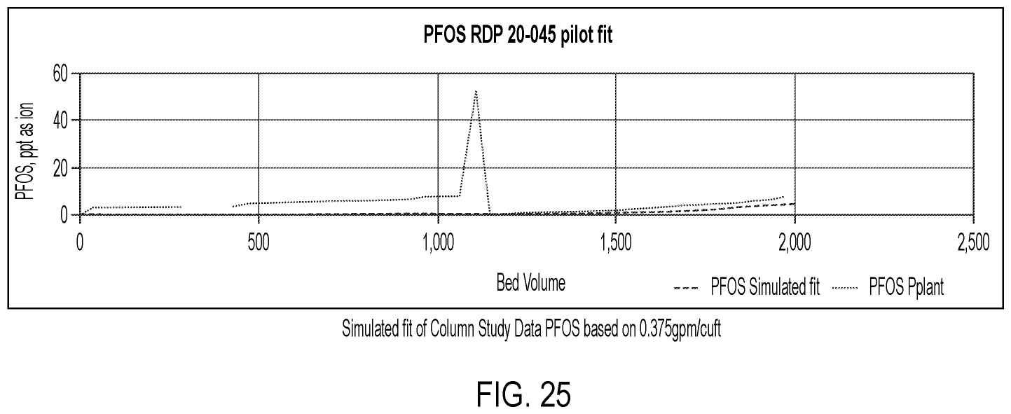

FIGS. 23-25 show examples of theoretical simulated capacity/leakages fits to the column exhaustion data using proprietary simulation software. The column study was paused when breakthrough occurred. After a pause the columns were started at ½ of the previous flow rate. Note that the observed jump in the pilot data occurred during a flow rate adjustment, where the columns were paused. The simulated fits in the figures were extrapolated as though the entire column study was run at 0.375 gpm per cubic foot ( 1/20 BV/min); for reference, 1000 BV is 13.8 days of run length at this flow rate. It is obvious that the slower flowrate gave significantly higher throughput capacity. The working zone of the resin is a function of the flowrate. The slower flow has a smaller working zone, so more of the resin gets used before the breakthrough occurs.

The following discussion addresses economic considerations that apply to the general topic of long-lived resins, including DMAE resin, used in single cycle applications. In virtually all PFAS removal installations to date, the ion-exchange resins are used once, and replaced when the resins become exhausted. Due to the long cycle times of the resins, it is not practical to have in-plant regeneration equipment in place for regenerations that might take place once every year or two. To add to this, the regenerant waste would contain all of the removed PFASs, at a high concentration. Thus, at present, best practices dictate a one-time use of the resin, followed by high temperature incineration to destroy the PFASs on the resin.

All resin performance estimates are based on properly pretreated influents. When ion exchange resins are used in single use applications without regeneration, it is important that the influent water be free of interfering substances, and care needs to be taken to ensure against outside factors interfering with the exhaustion cycle. Particulate matter, NOMs, oxidizing substances, and foulants should be avoided. Poor quality influents will make it difficult for the resin to achieve its performance objective.

Backwashing the bed of an ion exchange system is not recommended for long-life resins because it displaces exhausted resin to the bottom of the bed, and increases leakage.

Increased pressure loss in an ion exchange system can be dealt with in a variety of ways. For example, the upper portion of the resin bed can be backwashed in a variety of ways that allow the back-wash water to be filtered and fed into the influent. Alternatively, the top portion of the resin bed can be removed. Core samples of the bed can help predict the portion of the resin bed that can be removed, and its impact on remaining capacity.

If it becomes necessary to backwash the entire resin bed, any such backwash should be carried out at reduced expansion, which can be tested for, so that minimal impact to the size distribution occurs. This can help avoid, or at least reduce, the amount of leakage caused by the backwash.

If the ion exchange system includes backwash capability, it is suggested that backwashing only be performed as needed, and preferably under a lower flow rate than a typical backwash, e.g., at 25-35 percent expansion instead of 50 percent. Minimum expansion can move the bed such in a way that the larger particles remain at the bottom, while the smaller particles can be moved through the resin bed, to the upper portion of the bed. Backwashing should proceed until all the water entering the vessel at the bottom leaves through the top of the vessel, taking any of the entrained matter with it. Once the flow rate is established, the backwash should last at least 30 minutes.

The following discussion addresses economic considerations relating to operating requirements for ion exchange systems used for PFAS removal. The equipment sizes in an ion exchange system vary with the content, or internal volume of the system, with wider vessels costing more to manufacture for a specified internal volume. For a specified flow rate, the pressure loss increases inversely with tank diameter at the higher flow rates per unit area. In PFAS removal applications, area-based flow may be significantly less than in a multi-cycle system. Two factors need to be considered when sizing the ion exchange system: resin bed height versus pressure loss; and pumping costs versus flow rate factors.

Bed height limitations for single use applications are not directly a factor. Although column length can add complexity, bed heights of 12 feet or higher, in general, are not problematic, except for the difficulties associated with providing backwash capability in such high beds. A two-tank worker/polisher configuration can be advantageous for two reasons. Two tanks allow for smaller tanks. Also, the second tank provides an additional safety factor; if the working bed has a leakage upset, the polishing bed can trap the liberated PFASs, avoiding effluent leakage from the system.

The features and functions described above, as well as alternatives, may be combined into many other different systems or applications. Various alternatives, modifications, variations or improvements may be made by those skilled in the art, each of which is also intended to be encompassed by the disclosed embodiments.

We claim:

1. A process for removing perfluoroalkyl and/or polyfluoroalkyl substances from a fluid, comprising:
providing an ion exchange system comprising a column defining an internal volume, and a bed of dimethylethanolamine resin disposed in the internal volume; and
introducing the fluid into the column so that the fluid contacts the dimethylethanolamine resin.

2. The process of claim 1, wherein introducing the fluid into the column so that the fluid contacts the dimethylethanolamine resin comprises introducing the fluid into the column so that the fluid contacts the dimethylethanolamine resin for a length of time sufficient to cause the perfluoroalkyl and/or polyfluoroalkyl substances to become deposited on the dimethylethanolamine resin.

3. The process of claim 2, wherein introducing the fluid into the column so that the fluid contacts the dimethylethanolamine resin for a length of time sufficient to cause the perfluoroalkyl and/or polyfluoroalkyl substances to become deposited on the dimethylethanolamine resin comprises controlling a flow rate of the fluid through the column.

4. The process of claim 1, wherein introducing the fluid into the column so that the fluid contacts the dimethylethanolamine resin comprises introducing the fluid into the column so that the fluid passes through the bed of dimethylethanolamine resin.

5. The process of claim 1, wherein providing an ion exchange system comprising a column defining an internal volume, and a bed of dimethylethanolamine resin disposed in the internal volume comprises providing an ion exchange system comprising a bed of dimethylethanolamine resin beads.

6. A process for purifying water, comprising placing the water in contact with a dimethylethanolamine resin for a period of time sufficient to remove perfluoroalkyl and/or polyfluoroalkyl substances from the water.

7. The process of claim 6, wherein placing the water in contact with a dimethylethanolamine resin for a period of time sufficient to remove perfluoroalkyl and/or polyfluoroalkyl substances from the water comprises placing the water in contact with the dimethylethanolamine resin for a period of time sufficient for the perfluoroalkyl and/or polyfluoroalkyl substances to become deposited on the dimethylethanolamine resin.

8. The process of claim 6, wherein placing the water in contact with a dimethylethanolamine resin for a period of time sufficient to remove perfluoroalkyl and/or polyfluoroalkyl substances from the water comprises placing the water in contact with a bed of dimethylethanolamine resin beads for a period of time sufficient to remove perfluoroalkyl and/or polyfluoroalkyl substances from the water.

9. The process of claim 8, wherein placing the water in contact with a bed of dimethylethanolamine resin beads for a period of time sufficient to remove perfluoroalkyl and/or polyfluoroalkyl substances from the water comprises controlling a flowrate of the water over the bed of dimethylethanolamine resin beads.

10. An ion exchange system for removing perfluoroalkyl and/or polyfluoroalkyl substances from a fluid, comprising:
a column defining an internal volume;
a bed of dimethylethanolamine resin disposed in the internal volume; and
a valve system configured to, during operation, control a flowrate of the fluid through the column.

11. The system of claim 10, wherein: the valve system comprises an inlet valve configured to meter an inflow of the fluid into the internal volume; and an outlet valve configured to meter an outflow of the fluid from the internal volume.

12. The system of claim 11, further comprising a controller configured to control opening and closing of the inlet and outlet valves.

13. The system of claim 10, wherein the bed of dimethylethanolamine resin comprises a bed of dimethylethanolamine resin beads.

14. The system of claim 10, further comprising a layer of activated carbon disposed in the internal volume.
